(19) United States
(12) Patent Application Publication
(10) Pub. No.: US 2013/0245020 A1
(43) Pub. Date: Sep. 19, 2013

(54) SYNERGISTIC ANTIMICROBIAL COMPOSITION

(71) Applicant: DOW GLOBAL TECHNOLOGIES LLC, Midland, MI (US)

(72) Inventor: Bei Yin, Buffalo Grove, IL (US)

(73) Assignee: DOW GLOBAL TECHNOLOGIES LLC, Midland, MI (US)

(21) Appl. No.: 13/866,623

(22) Filed: Apr. 19, 2013

Related U.S. Application Data
(62) Division of application No. 13/496,946, filed on Mar. 19, 2012, now Pat. No. 8,445,521.

(51) Int. Cl. A01N 43/66; A01N 31/08

(52) U.S. Cl. CPC A01N 43/66; A01N 31/08
USPC 514/241

(57) ABSTRACT

A synergistic antimicrobial composition. The composition contains at least two components. The first component is ortho-phenylphenol or its alkali metal or ammonium salts. The second component is 4,4-dimethyloxazolidine (DMOZ).

This invention relates to combinations of biocides, the combinations having greater activity than would be observed for the individual antimicrobial compounds.

Use of combinations of at least two antimicrobial compounds can broaden potential markets, reduce use concentrations and costs, and reduce waste. In some cases, commercial antimicrobial compounds cannot provide effective control of microorganisms, even at high use concentrations, due to weak activity against certain types of microorganisms, or relatively slow antimicrobial action, or instability under certain conditions such as high temperature and high pH. Combinations of different antimicrobial compounds are sometimes used to provide overall control of microorganisms or to provide the same level of microbial control at lower use rates in a particular end use environment. For example, U.S. Pat. No. 7,262,222 discloses combinations of ortho-phenylphenol and a guanidine biocide or a quaternary ammonium biocide, but this reference does not suggest any of the combinations claimed herein. Moreover, there is a need for additional combinations of antimicrobial compounds having enhanced activity to provide effective control of microorganisms. The problem addressed by this invention is to provide such combinations of antimicrobial compounds.

### STATEMENT OF THE INVENTION

The present invention is directed to a synergistic antimicrobial composition comprising: (a) ortho-phenylphenol or its alkali metal or ammonium salts; and (b) 4,4-dimethyloxazolidine (DMOZ); wherein a weight ratio of ortho-phenylphenol or its alkali metal or ammonium salts to 4,4-dimethyloxazolidine is from 4:1 to 1:15.

The present invention is further directed to a synergistic antimicrobial composition comprising: (a) ortho-phenylphenol or its alkali metal or ammonium salts; and (b) tris(hydroxymethyl)nitromethane (Tris Nitro); wherein a weight ratio of ortho-phenylphenol or its alkali metal or ammonium salts to tris(hydroxymethyl)nitromethane is from 15:1 to 1:15.

The present invention is further directed to a synergistic antimicrobial composition comprising: (a) ortho-phenylphenol or its alkali metal or ammonium salts; and (b) hexahydro-1,3,5-tris(2-hydroxyethyl)-s-triazine (HHT); wherein a weight ratio of ortho-phenylphenol or its alkali metal or ammonium salts to hexahydro-1,3,5-tris(2-hydroxyethyl)-s-triazine is from 15:1 to 1:15.

### DETAILED DESCRIPTION OF THE INVENTION

As used herein, the following terms have the designated definitions, unless the context clearly indicates otherwise. The term “antimicrobial compound” refers to a compound capable of inhibiting the growth or propagation of microorganisms, and/or killing microorganisms; antimicrobial compounds include bactericides, bacteristats, fungicides, fungistats, algaecides and algistats, depending on the dose level applied, system conditions and the level of microbial control desired. The term “microorganism” includes, for example, fungi (such as yeast and mold), bacteria and algae. The following abbreviations are used throughout the specification: ppm=parts per million by weight (weight/weight), mL=milliliter, Unless otherwise specified, temperatures are in degrees centigrade (° C.), and references to percentages are by weight (wt %). Percentages of antimicrobial compounds in the composition of this invention are based on the total weight of active ingredients in the composition, i.e., the antimicrobial compounds themselves, exclusive of any amounts of solvents, carriers, dispersants, stabilizers or other materials which may be present. Ortho-phenylphenol or its alkali metal or ammonium salts includes lithium, sodium, potassium, rubidium, cesium and ammonium salts. If more than one form of ortho-phenylphenol is present, the biocide ratio is calculated from the total content of such compounds. In some embodiments of the invention, sodium o-phenylphenylate (NaOPP) is used.

In some embodiments of the invention, a weight ratio of the ortho-phenylphenol or its alkali metal or ammonium salts to 4,4-dimethyloxazolidine (DMOZ) is from 3:1 to 1:12, alternatively from 3:1 to 1:10, alternatively from 3:1 to 1:9, alternatively from 2:1 to 1:15, alternatively from 2:1 to 1:10, alternatively from 1:1 to 1:12, alternatively from 1:1 to 1:10, alternatively from 1:1 to 1:9.

In some embodiments of the invention, a weight ratio of the ortho-phenylphenol or its alkali metal or ammonium salts to tris(hydroxymethyl)nitromethane (Tris Nitro) is from 15:1 to 1:12, alternatively from 15:1 to 1:10, alternatively from 12:1 to 1:12, alternatively from 12:1 to 1:10, alternatively from 10:1 to 1:10, alternatively from 10:1 to 1:9, alternatively from 9:1 to 1:9.

In some embodiments of the invention, a weight ratio of the ortho-phenylphenol or its alkali metal or ammonium salts to hexahydro-1,3,5-tris(2-hydroxyethyl)-s-triazine is from 12:1 to 1:15, alternatively from 10:1 to 1:15, alternatively from 10:1 to 1:12, alternatively from 10:1 to 1:10, alternatively from 9:1 to 1:10, alternatively from 9:1 to 1:9.

In some embodiments of the invention, the antimicrobial combination of this invention is useful in oil and gas field injection, produced fluids, fracturing fluids and other functional fluids, oil and gas wells, oil and gas operation, separation, storage, and transportation systems, oil and gas pipelines, oil and gas vessels, and fuel. The combination is especially useful in aqueous fluids added to or produced by oil and gas well. The composition also is useful for controlling microorganisms in other industrial water and water containing/contaminated matrixes, such as cooling water, air washer, heat exchangers, boiler water, pulp and paper mill water, other industrial process water, ballast water, wastewater, metalworking fluids, latex, paint, coatings, adhesives, inks, tape joint compounds, pigment, water-based slurries, personal care and household products such as detergent, filtration systems (including reverse osmosis and ultrafiltration systems), toilet bowel, textiles, leather and leather production system, or a system used therewith.

Typically, the amount of the biocide combinations of the present invention to control the growth of microorganisms is from 10 ppm to 5,000 ppm active ingredient. In some embodiments of the invention, the active ingredients of the composition are present in an amount of at least 20 ppm, alternatively at least 50 ppm, alternatively at least 100 ppm, alternatively at least 150 ppm, alternatively at least 200 ppm. In some embodiments, the active ingredients of the composition are present in an amount of no more than 2,000 ppm, alternatively no more than 1,000 ppm, alternatively no more than 500 ppm, alternatively no more than 400 ppm, alternatively no more than 300 ppm, alternatively no more than 250 ppm, alternatively no more than 200 ppm, alternatively no more than 100 ppm, alternatively no more than 50 ppm. Concentrations mentioned above are in a liquid composition containing the biocide combinations. Biocide concentrations in a high-sulfide and high-temperature environment typically will be higher than in other environments.

The present invention also encompasses a method for reducing, or inhibiting, or preventing microbial growth in the use areas described above, especially in oil or natural gas production operations, by incorporating the claimed biocide combination into the materials.

### EXAMPLES

### Example 1

### Synergistic Effect of NaOPP and DMOZ or Tris Nitro or HHT Against Sulfate Reducing Bacteria (SRB)

Inside an anaerobic chamber (BACTRON anaerobic chamber), a deaerated sterile salt solution (3.1183 g of NaCl, 1.3082 mg of NaHCO₃, 47.70 mg of KCl, 72.00 mg of CaCl₂, 54.49 mg of MgSO₄, 172.28 mg of Na₂SO₄, 43.92 mg of Na₂CO₃ in 1 L water) was contaminated with an oil field isolated anaerobic consortium, mainly SRB, at final bacterial concentrations of 10⁶to10⁷ CFU/mL. The aliquots of this contaminated water were then treated with NaOPP and DMOZ, or the NaOPP/DMOZ combination, NaOPP and Tris Nitro, or the NaOPP/Tris Nitro combination, NaOPP and HHT, or the NaOPP/HHT combination at different active concentration levels. After the mixtures were incubated at 40° C. for 24 hours, the biocidal efficacy was determined by minimum tested biocide concentration for complete bacterial kill in the aliquots (MBC). Tables 1-3 summarize the efficacy of each biocide and their blends, and the Synergy Index of each combination.

TABLE 1
Biocidal efficacy of NaOPP, DMOZ and NaOPP/DMOZ combination
against anaerobic bacteria, and Synergy Index

| | | |
|---|---|---|
| | MBC (active | |
| Ratio of NaOPP to | ppm) | Synergy |

| DMOZ (active w/w) | NaOPP | DMOZ | Index* |
|---|---|---|---|
| 1:0 | 333.3 | 0.0 | |
| 9:1 | 181.8 | 20.2 | 0.82 |
| 3:1 | 133.3 | 44.4 | 1.00 |
| 1:1 | 49.4 | 49.4 | 0.81 |
| 1:3 | 14.1 | 42.3 | 0.61 |
| 1:9 | 5.2 | 46.8 | 0.65 |
| 0:1 | 0.0 | 74.1 | |

*Synergy Index = Ca/CA + Cb/CB
Ca: Concentration of biocide A required to achieve complete bacterial kill when used in combination with biocide B
CA: Concentration of biocide A required to achieve complete bacterial kill when used alone
Cb: Concentration of biocide B required to achieve complete bacterial kill when used in combination with biocide A
CB: Concentration of biocide B required to achieve complete bacterial kill when used alone

TABLE 2
Biocidal efficacy of NaOPP, Tris Nitro and NaOPP/Tris Nitro combination
against anaerobic bacteria, and Synergy Index

| | MBC | | |
|---|---|---|---|
| | (active ppm) | | |
| Ratio of NaOPP to Tris | | Tris | Synergy |
| Nitro (active w/w) | NaOPP | Nitro | Index |
| 1:0 | 500 | 0.0 | |
| 9:1 | 108.1 | 12.0 | 0.49 |
| 3:1 | 70.2 | 23.4 | 0.67 |
| 1:1 | 22.8 | 22.8 | 0.56 |
| 1:3 | 9.0 | 26.9 | 0.62 |
| 1:9 | 3.2 | 28.7 | 0.65 |
| 0:1 | 0.0 | 44.4 | |

TABLE 3
Biocidal efficacy of NaOPP, HHT and NaOPP/HHT combination against
anaerobic bacteria, and Synergy Index

| | | |
|---|---|---|
| | MBC (active | |
| Ratio of NaOPP to | ppm) | Synergy |

| HHT (active w/w) | NaOPP | HHT | Index |
|---|---|---|---|
| 1:0 | 500 | 0.0 | |
| 9:1 | 272.7 | 30.3 | 0.82 |
| 3:1 | 133.3 | 44.4 | 0.67 |
| 1:1 | 49.4 | 49.4 | 0.54 |
| 1:3 | 21.2 | 63.5 | 0.61 |
| 1:9 | 7.8 | 70.2 | 0.65 |
| 0:1 | 0.0 | 111.1 | |

### Example 2

### Synergistic Effect of NaOPP and DMOZ or Tris Nitro Against Aerobic Bacteria

A sterile NaC1 solution (0.85%) was contaminated with Pseudomonas aeruginosa, ATCC 10145 and Staphylococcus aureus, ATCC 6538 at final bacterial concentration of ca. 10⁶ CFU/mL. The aliquots of this contaminated water were then treated with NaOPP and Tris Nitro, or the NaOPP/Tris Nitro combination, NaOPP and DMOZ or the NaOPP/DMOZ combination at different active concentration levels. After the mixtures were incubated at 37° C. for 24 hours, the biocidal efficacy was determined by minimum tested biocide concentration for complete bacteria kill in the aliquots. Tables 4 and 5 summarize the efficacy of each biocide and their blends, and the Synergy Index of each combination.

TABLE 4
Biocidal efficacy of NaOPP, DMOZ and NaOPP/DMOZ combination
against aerobic bacteria, and Synergy Index

| | | | |
|---|---|---|---|
| | Average MBC | Average | |
| Ratio of NaOPP to | (active ppm) | Synergy | p value |

| DMOZ (active w/w) | NaOPP | DMOZ | Index | in ztest* |
|---|---|---|---|---|
| 1:0 | 292.9 | 0.0 | | |
| 8.12:1 | 209.6 | 25.7 | 1.03 | 0.53 |
| 2.86:1 | 111.9 | 38.8 | 0.85 | 0.00 |
| 1:1 | 50.9 | 50.9 | 0.78 | 0.00 |
| 1:2.86 | 19.3 | 55.2 | 0.72 | 0.00 |
| 1:8.12 | 6.8 | 55.2 | 0.67 | 0.00 |
| 0:1 | 0.0 | 86.1 | | |

*P value < 0.05 means that there is significant difference between the average Synergy Index and 1.00

TABLE 5
Biocidal efficacy of NaOPP, Tris Nitro, and NaOPP/Tris Nitro
combination against aerobic bacteria, and Synergy Index

| | |
|---|---|
| | MBC (active |
| Ratio of NaOPP | ppm) |

| to Tris Nitro (active | | Tris | Synergy |
|---|---|---|---|
| w/w) | NaOPP | Nitro | Index |
| 1:0 | 266.3 | 0.0 | |
| 8.12:1 | 93.2 | 11.4 | 0.81 |
| 2.86:1 | 55.2 | 19.1 | 0.97 |
| 1:1 | <14.9 | <14.9 | <0.65 |
| 1:2.86 | <6.8 | <19.3 | <0.79 |
| 1:8.12 | <2.4 | <19.3 | <0.78 |
| 0:1 | 0.0 | 25.1 | |

1. A synergistic antimicrobial composition comprising: (a) ortho-phenylphenol or its alkali metal or ammonium salts; and (b) hexahydro-1,3,5-tris(2-hydroxyethyl)-s-triazine;
wherein a weight ratio of ortho-phenylphenol or its alkali metal or ammonium salts to hexahydro-1,3,5-tris(2-hydroxyethyl)-s-triazine is from 15:1 to 1:15.

2. The composition of claim 1 in which the weight ratio is from 10:1 to 1:12.

3. The composition of claim 2 in which the weight ratio is from 9:1 to 1:10.
